(19) United States
(12) Patent Application Publication
(10) Pub. No.: US 2021/0138829 A1
(43) Pub. Date: May 13, 2021

(54) LOGO PRINTED WHEEL APPARATUS

(71) Applicants: Glen Fleming, Picayune, MS (US); Jerri Fleming, Picayune, MS (US)

(72) Inventors: Glen Fleming, Picayune, MS (US); Jerri Fleming, Picayune, MS (US)

(21) Appl. No.: 16/682,295

(22) Filed: Nov. 13, 2019

(51) Int. Cl. B60B 1/06

(52) U.S. Cl. CPC B60B 1/06; B60B 2310/616; B60B 2900/572

(57) ABSTRACT

A logo printed wheel apparatus for customizable advertising and self-expression includes a central hub having a plurality of mounting apertures extending therethrough. The mounting apertures are configured to mount to a vehicle a plurality of spokes coupled to the central hub. Each spoke radially extends from the central hub and has an outer surface. A plurality of logos is coupled to the outer surface of each of the plurality of spokes. An outer rim is coupled to the plurality of spokes. The outer rim is configured to receive a tire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wheel devices and more particularly pertains to a new wheel device for customizable advertising and self-expression.

### (2) Description of Related Art Including Information Disclosed Under 37 CFR 1.97 and 1.98

The prior art relates to wheel devices. Existing wheel devices typically employ hubcaps or adhesive devices to employ a customized logo or design element. Such devices are impermanent and may be removed either accidently or maliciously. They may also add a cheaper appearance to a vehicle. Prior art with a fully integrated design element sacrifices traditional wheel design with extra embellishments and added elements. Some integrated design elements may also diminish structural integrity of the wheel. The present invention seeks to maintain a traditional wheel design while adding a tasteful, permanent design element.

### BRIEF SUMMARY OF THE INVENTION

An embodiment of the disclosure meets the needs presented above by generally comprising a central hub having a plurality of mounting apertures extending therethrough. The mounting apertures are configured to mount to a vehicle a plurality of spokes coupled to the central hub. Each spoke radially extends from the central hub and has an outer surface. A plurality of logos is coupled to the outer surface of each of the plurality of spokes. An outer rim is coupled to the plurality of spokes. The outer rim is configured to receive a tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a logo printed wheel apparatus according to an embodiment of the disclosure.

FIG. 2 is a front elevation view of an embodiment of the disclosure.

FIG. 3 is an in-use view of an embodiment of the disclosure.

### DETAILED DESCRIPTION OF THE INVENTION

With reference now to the drawings, and in particular to FIGS. 1 through 3 thereof, a new wheel device embodying the principles and concepts of an embodiment of the disclosure and generally designated by the reference numeral 10 will be described.

As best illustrated in FIGS. 1 through 3, the logo printed wheel apparatus 10 generally comprises a central hub 12 having a plurality of mounting apertures 14 extending therethrough. The central hub 12 may have an inner extended portion 16 and an outer portion 18. The mounting apertures 14 extend through the outer portion 18 and are configured to mount to a vehicle. The central hub 12 may be a manual-locking or automatic locking hub for four wheel drive vehicles. The plurality of mounting apertures 14 may be five evenly spaced mounting apertures 14 or any other pattern configured to fit a standard bolt pattern of the vehicle. A plurality of spokes 20 is coupled to the central hub 12. Each spoke 20 radially extends from the central hub 12, each spoke 20 has an outer surface 22.

A plurality of logos 24 is coupled to the outer surface 22 of each of the plurality of spokes 20. Each logo 24 may be powder coated paint applied directly to the spoke 20. Each logo 24 is oriented along the spoke 20 such that a rightmost spoke 26 of the plurality of spokes at any given time has the logo 24 legibly oriented. The logo 24 may be used for advertising or personal expression, and may be, but is not limited to, a word, a brand, a sports team logo, an image or the like. An outer rim 28 is coupled to the plurality of spokes 20. The outer rim 28 may have an extended outer edge 30. The outer rim 28 is configured to receive a tire 32. The outer edge 30 may have a lip 34 to help secure the tire 32. An overall diameter of the apparatus 10 conforms to standard wheel sizes ranging from 15 to 24 inches.

In use, the apparatus 10 is installed like a traditional wheel on a vehicle and is used to advertise, for self-expression, pride, or whatever desired purpose a user may have.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A logo printed wheel apparatus comprising:
a central hub, the central hub having a plurality of mounting apertures extending therethrough, the mounting apertures being configured to mount to a vehicle;
a plurality of spokes coupled to the central hub, each spoke radially extending from the central hub, each spoke having an outer surface;
a plurality of logos coupled to the plurality of spokes, each logo being coupled to the outer surface; and
an outer rim coupled to the plurality of spokes, the outer rim being configured to receive a tire.

2. The logo printed wheel apparatus of claim 1 further comprising each logo being powder coated paint applied directly to the spoke.

3. The logo printed wheel apparatus of claim 1 further comprising the logo being a sports team logo.

4. The logo printed wheel apparatus of claim 1 further comprising the logo being a printed word.

5. The logo printed wheel apparatus of claim 1 further comprising each logo being oriented along the spoke such that a rightmost spoke of the plurality of spokes at any given time has the logo legibly oriented.

6. The logo printed wheel apparatus of claim 1 further comprising the central hub having an inner extended portion and an outer portion, the mounting apertures extending through the outer portion.

7. The logo printed wheel apparatus of claim 1 further comprising the outer rim having an extended outer edge.

8. A logo printed wheel apparatus comprising:
a central hub, the central hub having a plurality of mounting apertures extending therethrough, the central hub having an inner extended portion and an outer portion, the mounting apertures extending through the outer portion, the mounting apertures being configured to mount to a vehicle;
a plurality of spokes coupled to the central hub, each spoke radially extending from the central hub, each spoke having an outer surface;
a plurality of logos coupled to the plurality of spokes, each logo being coupled to the outer surface, each logo being powder coated paint applied directly to the spoke, each logo being oriented along the spoke such that a rightmost spoke of the plurality of spokes at any given time has the logo legibly oriented; and
an outer rim coupled to the plurality of spokes, the outer rim having an extended outer edge, the outer rim being configured to receive a tire.
